(19) United States
(12) Patent Application Publication
(10) Pub. No.: US 2010/0093225 A1
(43) Pub. Date: Apr. 15, 2010

(54) EASY-TO-DISASSEMBLE COMBINATION-TYPE TERMINAL BLOCK

(76) Inventor: Shang Tsai WU, Taipei Hsien (TW)

Correspondence Address: BIRCH STEWART KOLASCH & BIRCH, PO BOX 747, FALLS CHURCH, VA, 22040-0747, US

(21) Appl. No.: 12/252,089

(22) Filed: Oct. 15, 2008

(51) Int. Cl. H01R 24/04

(52) U.S. Cl. 439/668

(57) ABSTRACT

An easy-to-disassemble combination-type terminal block mainly includes: a plug having a receiving space and an outer end formed with a projection; and a base having an oblong shape corresponding to the plug and having a side formed with a mouth for mating with the projection, wherein the mouth has at least one side thereof provided with a continuous reinforcing rib having a predetermined thickness. When the projection of the plug is mated with the mouth of the base, a gap is formed between the projection and the reinforcing rib at a periphery of the mouth. A flat end of a force-applying tool, such as a screwdriver, can be inserted into the gap between the projection and the reinforcing rib at the periphery of the mouth, so that the plug can be separated from the base effortlessly and safely by rotating the flat end of the force-applying tool.

### BACKGROUND OF THE INVENTION

1. Technical Field

The present invention relates to a terminal block, and more particularly, to a combination-type terminal block that is easy to disassemble by applying a force thereto with a force-applying tool, such as a screwdriver.

2. Description of Related Art

A conventional combination-type terminal block is composed of a plug and a base that can mate with and disengage from each other to facilitate change of terminals and connectors. However, the plug and the base, once coupled together, are difficult to separate. FIGS. 1 and 2 illustrate a conventional connector including a plug 50 and a base 60. The plug 50 has an oblong body which is provided with a receiving space therein, peripherally formed with a plurality of holes, and further provided with securing elements for receiving and securing terminals at wire ends (not shown). The plug 50 is characterized by having an outer end formed with a projection 51.

The base 60 has an oblong body corresponding to the plug 50 and having a side formed with a mouth 600 for mating with the projection 51 of the plug 50. The plug 50 can be provided internally with terminals that correspond to and match with a socket on a circuit board 80.

In order to ensure secure and reliable electrical connection between the plug 50 and the base 60 in the aforesaid combination-type terminal block, the matching terminals must be in very close contact. Consequently, it is required that the projection 51 be fitted tightly in the mouth 600. However, in case the projection 51 and the mouth 600 are not accurately aligned when mating with each other and need to be mated again, or in case one of them is damaged and has to be removed for replacing components thereof, it is very likely that the plug 50 cannot be separated from the base 60 with ease. Instead, a user may have to use both hands to pull the plug 50 out of the base 60 with force. If a metal tool is used to pry them apart, chances are the thin and fragile plastic walls of the plug 50 and the base 60 will be broken. This is one major drawback of the conventional combination-type terminal block.

Furthermore, referring to FIG. 2, when the terminal blocks are secured to the circuit board 80, the terminal blocks must be spaced sufficiently apart to facilitate disassembly thereof. For example, a predetermined distance D is reserved between two adjacent plugs 50, so that a user can separate the plug 50 from the base 60 with his/her hand 70 when needed. However, as described above, even with the predetermined spacing, force application remains difficult while trying to pull the plug 50 out. Moreover, the plug 50 tends to be damaged if pulled out forcibly from the circuit board 80. This constitutes another major drawback of the prior art in use.

On the other hand, it will be extremely cost-inefficient to design a complicated ejection device capable of mechanical advantage for such basic and simple components as the terminal blocks. Hence, improvement is called for to lead the industry out of this dilemma.

### BRIEF SUMMARY OF THE INVENTION

A primary objective of the invention is to provide a novel structural design for a terminal block, in which a reinforcing rib is provided at a specific location on a side of the simply structured conventional terminal block, so that a plug and a base of the terminal block can be separated conveniently by using a force-applying tool such as a screwdriver. In addition, the reinforcing rib also increases the thickness of plastic walls of the terminal block to prevent the terminal block from breaking and being damaged.

In order to achieve the foregoing objective effectively, the terminal block of the present invention can be implemented by:

providing a plug having an oblong body which is formed therein with a receiving space and further provided with securing elements for receiving and securing terminals at wire ends, wherein the plug has an outer end formed with a projection; and

providing a base having an oblong body corresponding to the plug and having a side formed with a mouth for mating with the projection of the plug, wherein the mouth has at least one side thereof formed with a continuous reinforcing rib having a predetermined thickness.

When the projection of the plug is mated with the mouth of the base, a foolproof fastener on the plug and a foolproof groove on the base also mate with each other while a gap is formed between the projection and the reinforcing rib at a periphery of the mouth. A flat end of a force-applying tool, such as a screwdriver, can be inserted into the gap between the projection and the reinforcing rib at the periphery of the mouth, so that the plug can be separated from the base effortlessly and safely by rotating the flat end of the force-applying tool.

### BRIEF DESCRIPTION OF THE SEVERAL VIEWS OF THE DRAWINGS

The invention as well as a preferred mode of use, further objectives and advantages thereof will be best understood by referring to the following detailed description of an illustrative embodiment in conjunction with the accompanying drawings, wherein:

FIG. 1 is an exploded view of a conventional combination-type terminal block, showing a plug and a base thereof;

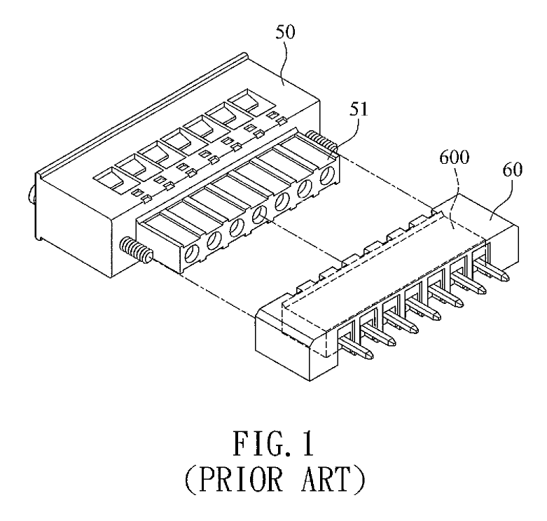

FIG. 2 is a schematic view showing positions of the conventional combination-type terminal blocks on a circuit board;

FIG. 3 is an exploded view of a combination-type terminal block according to the present invention, showing a plug and a base thereof;

FIG. 4 is an assembled view of the plug and the base of the present invention;

FIG. 5 is a schematic view showing the terminal block being disassembled by a screwdriver according to the present invention; and

FIG. 6 is a plane view showing rotation of a flat end of the screwdriver while disassembling the terminal block of the present invention.

### DETAILED DESCRIPTION OF THE INVENTION

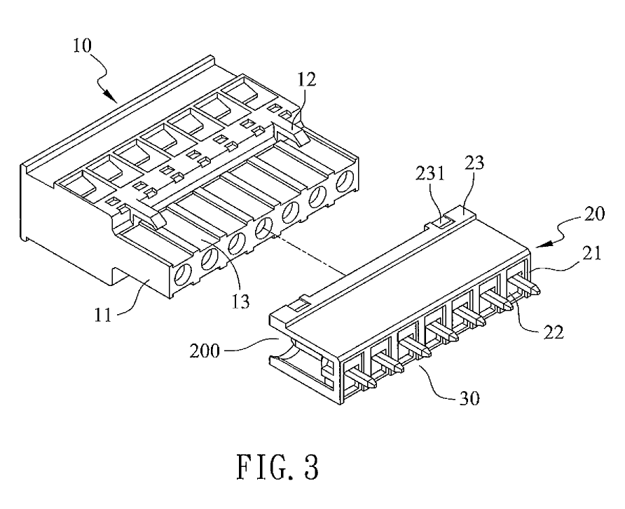

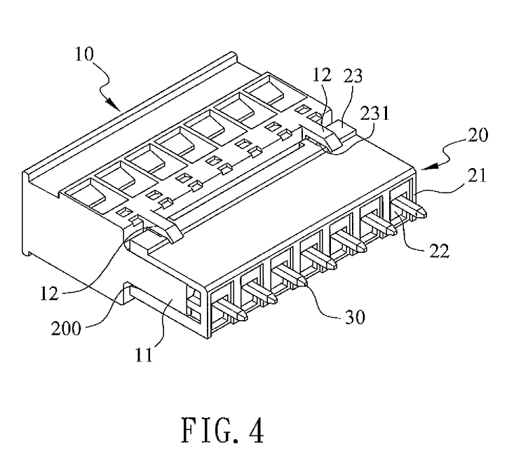

Referring to FIGS. 3 and 4, a terminal block according to the present invention comprises a plug 10 and a base 20. The plug 10 has an oblong body which is formed therein with a receiving space, peripherally provided a plurality of holes and further provided with securing elements for receiving and securing terminals at wire ends. (The aforesaid structures are not the subject matter of the present invention and therefore not labeled in the drawings.) The plug 10 is characterized by having an outer end formed with a projection 11, wherein the projection 11 has a surface formed with channels 13 for increasing structural strength and reducing weight. In addition, a plurality of foolproof fasteners 12 are provided at appropriate locations on the projection 11. The foolproof fasteners 12 protrude from the projection 11.

The base 20 has an oblong body corresponding to the plug 10 and having a side formed with a mouth 200 for mating with the projection 11 of the plug 10, wherein the mouth 200 has at least one side thereof formed with a continuous reinforcing rib 23 having a predetermined thickness. Alternatively, the reinforcing rib 23 is configured so as to continuously sealingly encircle a periphery of the mouth 200. The reinforcing rib 23 is further provided with foolproof grooves 231 corresponding in position to the foolproof fasteners 12 on the projection 11 of the plug 10. In addition, the base 20 has a lateral side 21 formed with through grooves 22 for receiving terminals 30 therein and aligning the terminals 30 with a circuit board (not shown). The foolproof grooves 231 on the base 20 and the foolproof fasteners 12 on the projection 11 of the plug 10 are interchangeable in position (not shown).

When the projection 11 of the plug 10 is mated with the mouth 200 of the base 20, the foolproof fasteners 12 also mate with the foolproof grooves 231. Meanwhile, a gap is formed between the projection 11 and the reinforcing rib 23 at the periphery of the mouth 200.

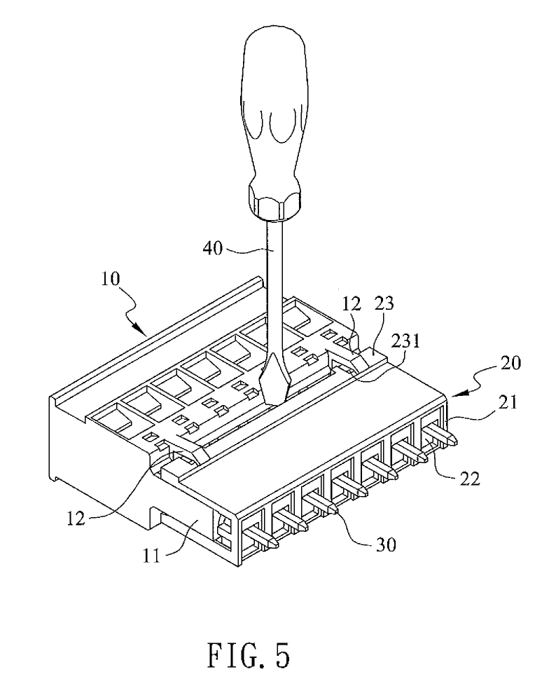

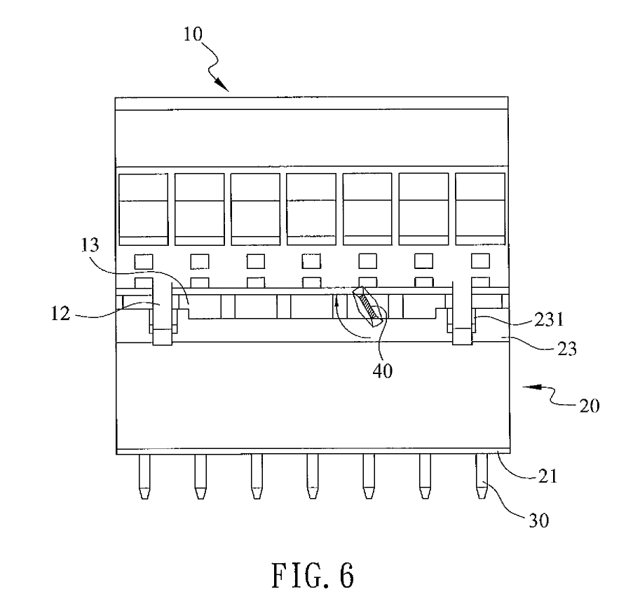

Referring now to FIGS. 4, 5 and 6, when it is desired to separate the plug 10 from the base 20, a user can insert a flat end of a force-applying tool 40 (such as a screwdriver) into the gap between the projection 11 and the reinforcing rib 23 on the mouth 200, and then rotate the flat end of the force-applying tool 40 to force the plug 10 slightly apart from the base 20. Alternatively, the force-applying tool 40 may be used to gently pry open the gap at both ends thereof to facilitate detachment of the plug 10 from the base 20. In either way, the terminal block can be disassembled in a very convenient manner without damaging its elements.

Implementation of the present invention can provide the following advantageous effects:

According to the present invention, when the projection of the plug is mated with the mouth of the base, the at least one side of the mouth where the reinforcing rib is located provides access to a force-applying tool for separating the plug from the base, thereby offering convenience of use. Meanwhile, the reinforcing rib having the predetermined thickness serves to protect internal components of the terminal block from being damaged, and housings of the terminal block from breaking due to compression. Hence, the present invention provides not only a breakthrough in combination-type terminal blocks, but also a product having non-obviousness and industrial applicability.

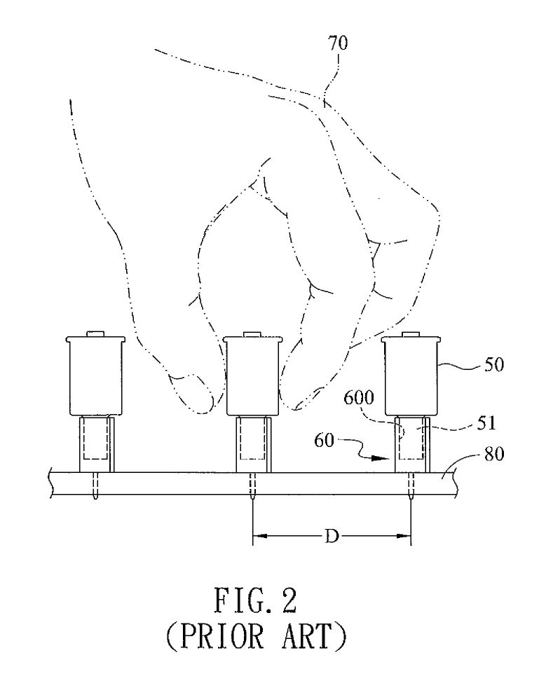

Since the plug and the base of the present invention can be separated simply by using a force-applying tool, there is no need to keep a large distance, such as the distance D shown in FIG. 2, between adjacent terminal blocks on a circuit board. Therefore, as another advantage of the present invention, components on the circuit board can be mounted more densely to reduce the total volume occupied.

The present invention provides a structural design in which the projection of the plug is mated with the mouth of the base, and the reinforcing rib is provided on at least one side of the mouth. It should be noted that this design is not limited by the configuration of the terminal block. For example, the terminal block may be configured in such a way that after the projection of the plug is mated with the mouth of the base the reinforcing rib is located on a plane perpendicular or parallel to a horizontal plane, for example, the horizontal plane of a circuit board, or is even located on an inclined plane. However, as long as the mouth is provided with the reinforcing rib on at least one side thereof or at a periphery thereof the terminal block falls within the technical field of the present invention and should be encompassed by the appended claims.

In conclusion, the present invention shows industrial applicability by providing such advantages as convenience of use, structural safety, effortless disassembly and economy of space. Moreover, the present invention has never been put to public use and thus meets the requirements for patent application. Therefore, an application for patent of the present invention is hereby filed for examination.

1. An easy-to-disassemble combination-type terminal block, comprising:
a plug having an oblong body which is formed therein with a receiving space and provided with securing elements for receiving and securing terminals at wire ends, wherein the plug has an outer end formed with a projection; and
a base having an oblong body corresponding to the plug and having a side formed with a mouth for mating with the projection of the plug, wherein the mouth has at least one side thereof provided with a continuous reinforcing rib having a predetermined thickness.

2. The easy-to-disassemble combination-type terminal block of claim 1, wherein the projection of the plug has a surface formed with channels.

3. The easy-to-disassemble combination-type terminal block of claim 1, wherein the projection of the plug is provided with at least one protruding foolproof fastener.

4. The easy-to-disassemble combination-type terminal block of claim 1, wherein the reinforcing rib on at least one side of the mouth of the base continuously sealingly encircles a periphery of the mouth.

5. The easy-to-disassemble combination-type terminal block of claim 3, wherein the mouth of the base is provided with a foolproof groove corresponding in position to the foolproof fastener on the projection of the plug.

6. The easy-to-disassemble combination-type terminal block of claim 1, wherein after the projection of the plug and the mouth of the base are mated, the reinforcing rib is located on a plane perpendicular to a horizontal plane.

7. The easy-to-disassemble combination-type terminal block of claim 1, wherein after the projection of the plug and the mouth of the base are mated, the reinforcing rib is located on a plane parallel to a horizontal plane.

8. The easy-to-disassemble combination-type terminal block of claim 5, wherein the foolproof groove on the base and the foolproof fastener on the projection of the plug are interchangeable in position.
